(19) United States
(12) Patent Application Publication
(10) Pub. No.: US 2014/0286758 A1
(43) Pub. Date: Sep. 25, 2014

(54) NOZZLE RING WITH NON-UNIFORMLY DISTRIBUTED AIRFOILS AND UNIFORM THROAT AREA

(71) Applicant: ABB TURBO SYSTEMS AG, Baden (CH)

(72) Inventor: Stephan M. Senn, Remigen (CH)

(73) Assignee: ABB TURBO SYSTEMS AG, Baden (CH)

(21) Appl. No.: 14/190,814

(22) Filed: Feb. 26, 2014

(30) Foreign Application Priority Data
Mar. 19, 2013 (EP) 13159879.9

(51) Int. Cl. F02B 37/22

(52) U.S. Cl. CPC F02B 37/22
USPC 415/160

(57) ABSTRACT

A segmented nozzle ring is disclosed having a throat area between neighboring vanes that is the same for each segment which is achieved by rotation (i.e., opening or closing of the throat area) of the individual vane compounds belonging to the different segments. The resulting uniform throat area leads to a uniform exit flow angle of the nozzle and a uniform inlet flow angle of the rotor. As a result, high-cycle fatigue excitations of the rotor caused by the non-uniform flow can be eliminated, the thermodynamic efficiency of the turbine stage can be improved, and the nozzle ring need not be arranged in a fixed position relative to the gas inlet casing.

### RELATED APPLICATION(S)

This application claims priority under 35 U.S.C. §119 to European Patent Application No. 13159879.9 filed in Europe on Mar. 19, 2013, the entire content of which is hereby incorporated by reference in its entirety.

### FIELD

This disclosure relates to exhaust gas turbines of turbochargers for combustion engines, and for example, to a nozzle ring for guiding the exhaust gas flow in such a gas turbine.

### BACKGROUND INFORMATION

A known exhaust gas turbines of turbochargers for combustion engines with fixed turbine geometry includes a turbine nozzle for channeling the exhaust gases to a plurality of rotor blades. The turbine nozzle includes a plurality of circumferentially spaced stator vanes fixedly joined at their roots and tips to annular, radially inner and outer supporting rings. In case of a radial or mixed flow turbine, the stator vanes of the nozzle ring are fixed at their roots and tips to annular supporting rings being arranged next to each other on each opposing side of the flow channel.

As shown in FIG. 4, each of the nozzle vanes has an airfoil cross section with a leading edge, a trailing edge, and pressure and suction sides extending there between. The trailing edge of one vane is spaced from the suction side of an adjacent vane. Each of the vanes includes a throat line extending from the root to the tip on the vane suction side for defining with the trailing edge of an adjacent one of the vanes a throat of minimum throat area. Adjacent ones of the vanes define individual throat areas and collectively they define a total throat area. These areas are specified by each particular exhaust gas turbine design and are factors affecting performance of the turbocharger.

The total throat area can be obtained by providing substantially uniform individual throat areas between the adjacent vanes. Variations in throat area between adjacent vanes can provide undesirable aero-mechanical excitation pressure forces which may lead to undesirable vibration of the rotor blades disposed downstream from the nozzle.

U.S. Pat. No. 5,182,855 discloses a method of manufacturing a turbine nozzle for obtaining a predetermined value of throat area between adjacent vanes.

Nozzle rings for axial, radial, and mixed-flow turbocharger turbines can be commonly divided into two or more different segments including different number of nozzle vanes per angle. Compared to non-segmented nozzle rings with vanes that are uniformly distributed in a circumferential direction, the aerodynamic excitation of the rotor can be reduced and the mechanical integrity margin regarding high cycle fatigue can be improved.

An issue of the mentioned segmented nozzle ring design is that the nozzle throat area can differ from one segment to the other. Therefore, the exit flow angle of the nozzle can also differ from one segment to the other. Due to the non-uniformity of the flow, the rotor is excited in the first mode shapes and the thermodynamic efficiency of the turbine stage can be reduced compared to a stage with a nozzle ring having uniformly distributed vanes. Due to the non-uniformity of the flow, the nozzle ring is desirably arranged in a fixed position relative to the gas inlet casing.

### SUMMARY

A nozzle ring is disclosed for a turbine of an exhaust gas turbocharger, comprising: two supporting rings; and a plurality of circumferentially spaced vanes, each vane including: a root fixedly joined to one of the supporting rings; a tip fixedly joined to the other one of the supporting rings; a leading edge; a trailing edge; suction and pressure sides extending from the leading edge to the trailing edge and between the root and the tip; and a throat line extending from the root to the tip on the pressure side for defining a throat area with a trailing edge of an adjacent one of the vanes, the vanes being arranged in at least two segments, the segments having different vane per angle distribution, each segment including different numbers of vanes per angle, wherein the vanes are uniformly distributed in a circumferential direction within each segment and the throat area between neighboring vanes is the same for each pair of neighboring vanes in all segments.

An exhaust gas turbine is disclosed having a nozzle ring, which comprises: two supporting rings; and a plurality of circumferentially spaced vanes, each vane including: a root fixedly joined to one of the supporting rings; a tip fixedly joined to the other one of the supporting rings; a leading edge; a trailing edge; suction and pressure sides extending from the leading edge to the trailing edge and between the root and the tip; and a throat line extending from the root to the tip on the pressure side for defining a throat area with a trailing edge of an adjacent one of the vanes, the vanes being arranged in at least two segments, the segments having different vane per angle distribution, each segment including different numbers of vanes per angle, wherein the vanes are uniformly distributed in a circumferential direction within each segment and the throat area between neighboring vanes is the same for each pair of neighboring vanes in all segments.

A turbo charger is disclosed having a nozzle ring which comprises: two supporting rings; and a plurality of circumferentially spaced vanes, each vane including: a root fixedly joined to one of the supporting rings; a tip fixedly joined to the other one of the supporting rings; a leading edge; a trailing edge; suction and pressure sides extending from the leading edge to the trailing edge and between the root and the tip; and a throat line extending from the root to the tip on the pressure side for defining a throat area with a trailing edge of an adjacent one of the vanes, the vanes being arranged in at least two segments, the segments having different vane per angle distribution, each segment including different number of vanes per angle, wherein the vanes are uniformly distributed in a circumferential direction within each segment and the throat area between neighboring vanes is the same for each pair of neighboring vanes in all segments.

### BRIEF DESCRIPTION OF THE DRAWINGS

The accompanying drawings illustrate exemplary embodiments of the present disclosure. In such drawings:

FIG. 1 shows a nozzle ring for an axial turbocharger turbine with two segments and a uniform throat area, according to an exemplary embodiment of the disclosure;

FIG. 2 illustrates the vane rotation, for example closing (upper part of the drawing) and opening (lower part of the drawing), to achieve a constant throat area, according to an exemplary embodiment of the disclosure;

FIG. 3 shows a nozzle ring for a radial or mixed-flow turbocharger turbine with two segments and uniform throat area, according to an exemplary embodiment of the disclosure; and

FIG. 4 shows two neighboring vanes of a nozzle ring highlighting the throat area between the two vanes.

### DETAILED DESCRIPTION

Exemplary embodiments of the present disclosure provide a segmented nozzle ring including different numbers of nozzle vanes per segment which have uniform individual throat areas between the adjacent vanes.

For the segmented nozzle ring according to an exemplary embodiment of the disclosure, the throat area between neighboring vanes can be the same for each segment which is achieved by rotation (i.e., opening or closing of the throat area) of the individual vane compounds belonging to the different segments. The resulting uniform throat area can lead to a uniform exit flow angle of the nozzle and a uniform inlet flow angle of the rotor.

Based on that, high-cycle fatigue excitations of the rotor caused by the non-uniform flow can be eliminated, the thermodynamic efficiency of the turbine stage can be improved, and the nozzle ring need not be arranged in a fixed position relative to the gas inlet casing.

The thermodynamic efficiency of the turbine stage as well as the mechanical integrity margin of the rotor regarding high cycle fatigue can be improved. Higher rotor vanes can be realized providing an increased specific flow capacity. Aerodynamically improved rotor vanes can be used providing a higher thermodynamic efficiency. More compact products can be realized enabling reducing product costs. Higher thermodynamic efficiency allows to save engine fuel costs for the end customer. Because the nozzle ring should not be arranged in a fixed position relative to the gas inlet casing, a simpler and cheaper design can be realized which is easier and faster to mount, hence further enabling reducing product and service costs.

These and other advantages and features of the present disclosure will become apparent from the following description, taken in conjunction with the accompanying drawings, which illustrate, by way of example, principles of the disclosure.

Each vane of the nozzle ring includes a root fixedly joined to the inner supporting ring, a tip fixedly joined to the outer supporting ring, a leading edge facing in an upstream direction, a trailing edge facing in a downstream direction, and oppositely facing suction, or convex, and pressure, or concave, sides, extending from the leading edge to the trailing edge and between the root and the tip.

Adjacent ones of the vanes define there between a converging channel for channeling the combustion gases between the vane and through the throats and downstream therefrom to a conventional turbine rotor stage.

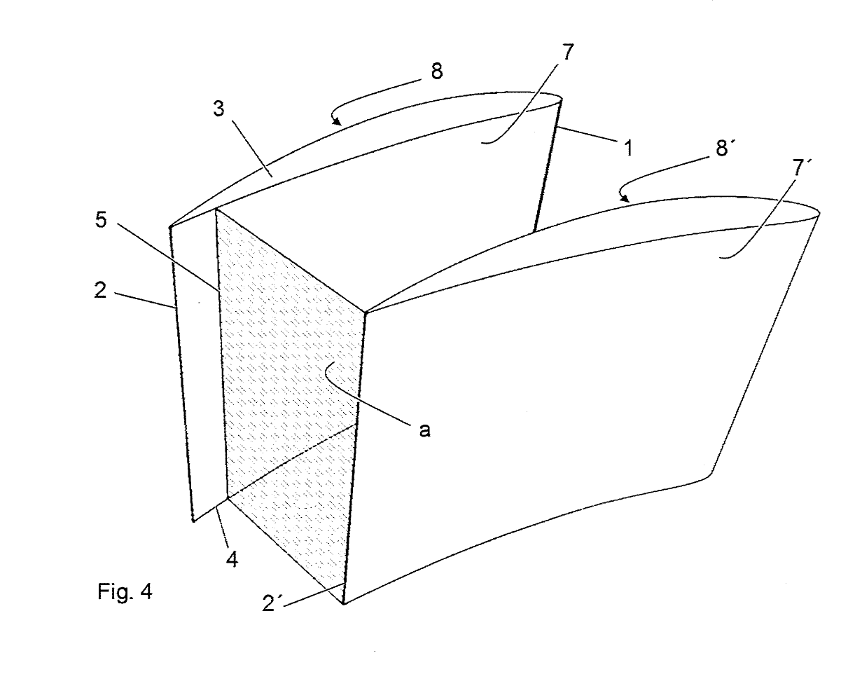

As stated above and shown in FIG. 4, each vane has a leading edge 1 and a trailing edge 2. Each vane has a root 4 fixedly joined to one of the supporting rings and a tip 3 fixedly joined to the other one of the supporting rings. The pressure side 7, 7′ and suction sides 8, 8′ extend from the leading edge 1 to the trailing edge 2 and between the root 4 and the tip 3. Each of the vanes includes a throat line 5 extending from the root 4 to the tip 3 on the vane pressure side 7 for defining with the trailing edge 2′ of an adjacent one of the vanes a throat of minimum throat area.

The nozzle ring includes two or more different segments. The segments include different number of vanes per angle. Within each individual segment, the vanes are uniformly distributed in circumferential direction. In contrast to known nozzle ring designs of that kind, the throat area between neighboring vanes is the same for each segment which is achieved by rotation (i.e., opening or closing) of the individual vane compounds belonging to the different segments.

The resulting uniform throat area can lead to a uniform exit flow angle of the nozzle and a uniform inlet flow angle of the rotor. Based on that, high-cycle fatigue excitations of the rotor caused by the non-uniform flow can be eliminated, the thermodynamic efficiency of the turbine stage can be improved, and the nozzle ring must not be arranged in a fixed position relative to the gas inlet casing.

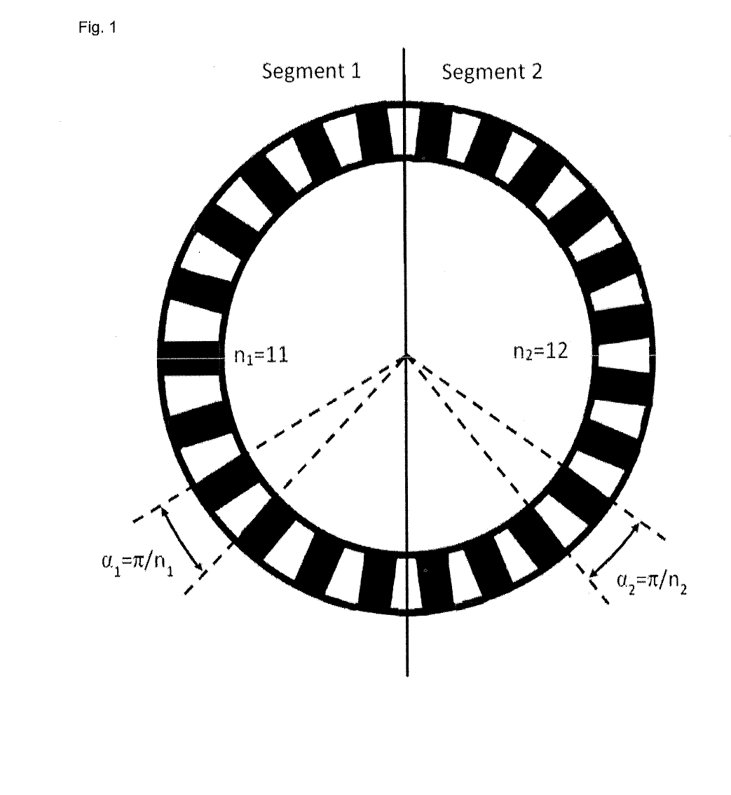

In FIG. 1, the nozzle ring for an axial turbocharger turbine stage is shown, including two segments (number of segments s=2). The first segment includes n₁=11 vanes, and the second segment includes n₂=12 vanes. For each segment, the vanes can be uniformly distributed in circumferential direction.

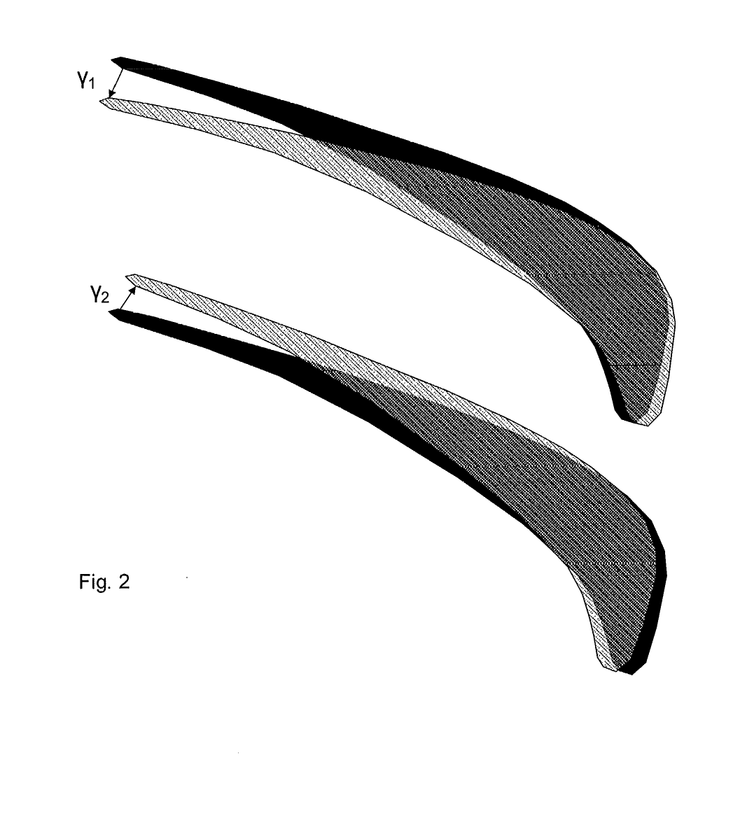

In segment 1, the angle between the vanes is α₁, in segment 2, the angle between the vanes is α₂, where α₁≠α₂ applies. To achieve equal throat areas between neighboring vanes for each segment, individual vane compounds belonging to the different segments are positioned at specific profile rotation angles by being rotated around an axis perpendicular to the profile and extending from the root to the tip of each vane in one or the other direction (i.e., closing or opening), as illustrated in FIG. 2. In the first segment, the vane compound is closed by the angle γ₁, thus reducing the enclosed area between a throat line extending from the root to the tip on the vanes pressure side and the trailing edge of the next vane. In the second segment, the vane compound is opened by the angle γ₂, thus enlarging the enclosed area between a throat line extending from the root to the tip on the vane pressure side and the trailing edge of the next vane. The specific profile rotation angles γ₁ and γ₂ of a segment are chosen such that the throat area of that segment, i.e. a₁ for segment 1, is identical to the throat area of the other segment, i.e. a₂ for segment 2, where a=a₁=a₂ corresponds to the targeted throat area a.

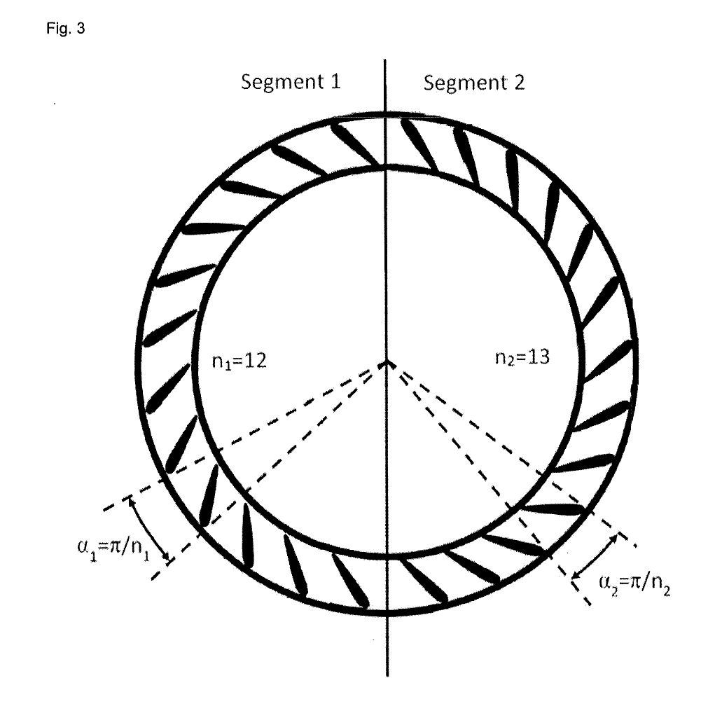

The same concept can also be applied to a nozzle ring of a radial or mixed-flow turbocharger turbine stage, as shown in FIG. 3.

Alternatively, the concept can be realized with arbitrary numbers of vanes and more than two segments, for example:

s≧2, n₁≧1, n_{2≧1}, . . . , nₛ≧1, nᵢ≠nⱼ, αᵢ≠αⱼ ∀i,j=1 . . . s,
where γ₁, γ₂, . . . , γₛ such that a₁=a₂= . . . =aₛ=a.

In an exemplary embodiment of the disclosure, equal throat areas between neighboring vanes for segments including different number of vanes per angle can be achieved by using different airfoil profiles for the vanes of the different segments.

Alternatively to the arrangement shown in FIG. 4, in an exemplary embodiment of the disclosure, the vanes can be arranged in such an angle that a throat line extending from the root to the tip on the vane suction side defines a throat of minimum throat area with the trailing edge of an adjacent one of the vanes.

While the disclosure has been described with reference to at least one exemplary embodiment, it is to be clearly understood by those skilled in the art that the disclosure is not limited thereto. Rather, the scope of the disclosure is to be interpreted only in conjunction with the appended claims.

Thus, it will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

### REFERENCE NUMBERS

1 leading edge of vane

2, 2′ trailing edge of vane

3 tip of vane

4 root of vane

5 throat line

7, 7′ pressure side of vane

8, 8′ suction side of vane

A a minimum throat area

nₛ number of vanes per segment

α₁, αⱼ angle between two neighboring vanes of a segment

γ₁, γ₂ vane profile rotation angle

What is claimed is:

1. A nozzle ring for a turbine of an exhaust gas turbocharger, comprising:
two supporting rings; and
a plurality of circumferentially spaced vanes, each vane including:
a root fixedly joined to one of the supporting rings;
a tip fixedly joined to the other one of the supporting rings;
a leading edge;
a trailing edge;
suction and pressure sides extending from the leading edge to the trailing edge and between the root and the tip; and
a throat line extending from the root to the tip on the pressure side for defining a throat area with a trailing edge of an adjacent one of the vanes, the vanes being arranged in at least two segments, the segments having different vane per angle distribution, each segment including different numbers of vanes per angle, wherein the vanes are uniformly distributed in a circumferential direction within each segment and the throat area between neighboring vanes is the same for each pair of neighboring vanes in all segments.

2. The nozzle ring as claimed in claim 1, wherein all vanes of a segment are positioned at specific profile rotation angles (γ₁, γ₂).

3. The nozzle ring as in claim 2, wherein the specific profile rotation angles (γ₁) of all vanes of a first segment differ from the specific profile rotation angles (γ₂) of all vanes of a second segment.

4. The nozzle ring as in claim 1, wherein the vanes of the nozzle ring have identical airfoil profiles.

5. The nozzle ring as in claim 2, wherein the vanes of the nozzle ring have identical airfoil profiles.

6. The nozzle ring as in claim 3, wherein the vanes of the nozzle ring have identical airfoil profiles.

7. The nozzle ring as in claim 1, wherein the airfoil profiles of the vanes of a first segment differ from the airfoil profiles of the vanes of a second segment.

8. The nozzle ring as in claim 2, wherein the airfoil profiles of the vanes of a first segment differ from the airfoil profiles of the vanes of a second segment.

9. The nozzle ring as in claim 3, wherein the airfoil profiles of the vanes of a first segment differ from the airfoil profiles of the vanes of a second segment.

10. An exhaust gas turbine having a nozzle ring, which comprises:
two supporting rings; and
a plurality of circumferentially spaced vanes, each vane including:
a root fixedly joined to one of the supporting rings;
a tip fixedly joined to the other one of the supporting rings;
a leading edge;
a trailing edge;
suction and pressure sides extending from the leading edge to the trailing edge and between the root and the tip; and
a throat line extending from the root to the tip on the pressure side for defining a throat area with a trailing edge of an adjacent one of the vanes, the vanes being arranged in at least two segments, the segments having different vane per angle distribution, each segment including different numbers of vanes per angle, wherein the vanes are uniformly distributed in a circumferential direction within each segment and the throat area between neighboring vanes is the same for each pair of neighboring vanes in all segments.

11. The exhaust gas turbine as claimed in claim 10, wherein all vanes of a segment are positioned at specific profile rotation angles (γ₁, γ₂).

12. The exhaust gas turbine as in claim 11, wherein the specific profile rotation angles (γ₁) of all vanes of a first segment differ from the specific profile rotation angles (γ₂) of all vanes of a second segment.

13. The exhaust gas turbine as in claim 10, wherein the vanes of the nozzle ring have identical airfoil profiles.

14. The exhaust gas turbine as in claim 12, wherein the vanes of the nozzle ring have identical airfoil profiles.

15. The exhaust gas turbine as in claim 11, wherein the airfoil profiles of the vanes of a first segment differ from the airfoil profiles of the vanes of a second segment.

16. A turbo charger having a nozzle ring, which comprises:
two supporting rings; and
a plurality of circumferentially spaced vanes, each vane including:
a root fixedly joined to one of the supporting rings;
a tip fixedly joined to the other one of the supporting rings;
a leading edge;
a trailing edge;
suction and pressure sides extending from the leading edge to the trailing edge and between the root and the tip; and
a throat line extending from the root to the tip on the pressure side for defining a throat area with a trailing edge of an adjacent one of the vanes, the vanes being arranged in at least two segments, the segments having different vane per angle distribution, each segment including different numbers of vanes per angle, wherein the vanes are uniformly distributed in a circumferential direction within each segment and the throat area between neighboring vanes is the same for each pair of neighboring vanes in all segments.

17. The turbo charger as claimed in claim 16, wherein all vanes of a segment are positioned at specific profile rotation angles (γ₁, γ₂).

18. The turbo charger as in claim 17, wherein the specific profile rotation angles (γ₁) of all vanes of a first segment differ from the specific profile rotation angles (γ₂) of all vanes of a second segment.

19. The turbo charger as in claim 16, wherein the vanes of the nozzle ring have identical airfoil profiles.

20. The turbo charger as in claim 16, wherein the airfoil profiles of the vanes of a first segment differ from the airfoil profiles of the vanes of a second segment.
